(19) United States
(12) Patent Application Publication
(10) Pub. No.: US 2007/0124686 A1
(43) Pub. Date: May 31, 2007

(54) Locating graphical elements for an object

(75) Inventors: Sundaram Ramani, Redmond, WA (US); Benjamin Carter, Redmond, WA (US); Robert Ingebretsen, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/280,080

(22) Filed: Nov. 16, 2005

(51) Int. Cl. G06F 17/30

(52) U.S. Cl. 715/741; 711/164; 707/1

(57) ABSTRACT

Locating a graphical element associated with an object includes obtaining a key for the object, using the key to determine a particular data table containing the graphical element, and using the key to obtain an identifier for the graphical element within the data table. Associating a particular graphical element with an object includes providing the graphical element at a particular location separate from the object, providing a key indicating the particular location and an identifier for the graphical element at the location, and associating the key with the object. Drawing a graphical element associated with an object includes locating the graphical element, wherein the graphical element is at a location different from the object and after locating the graphical element, drawing the graphical element. Locating the graphical element may include obtaining a key for the object, where the key indicates a particular resource dictionary and a particular location within the resource dictionary.

### BACKGROUND

Computer software applications may employ a graphical interface that facilitates user input and output. For example, an application may present a user with one or more windows representing different functional aspects of the application and/or representing different data that may be operated upon by the application. In addition, multiple applications may be present on a computer screen at the same time where the different applications are provided in different windows. Such operating systems also provide users with various options for inputting data including typing on the keyboard and using a mouse to click on menus, scrollbars, buttons, etc.

Although theoretically it is possible to have each application developer write all of the code necessary to present the user with a number of graphical elements, it is more often the case that the application developer uses tools for providing the graphical elements in connection with developing the application. The tools may be in the form of API calls made by the application code to present the various graphical elements and to receive user input through various graphic controls. The tools may be considered part of a presentation system which may be provided by the vendor of the operating system and/or by a third-party. The tools facilitate development of applications by eliminating the need for each application developer to reconstruct the code necessary to provide the graphical elements. In addition, the tools help to maintain a consistency of presentation for the graphical elements across different applications provided by different developers.

Some types of objects may have graphical elements associated with them. For example, a control object may have graphical elements associated with it that dictate how the control is presented to a user. In some cases the particular graphical element that is used may depend upon run time conditions, such as a user selected theme for a computer. It is possible to provide all of the graphical elements associated with an object in the same location as the object. Although such a scheme is relatively straightforward, there may be drawbacks, such as the inability to provide the objects and associated graphical elements separately (e.g., when updating the “look” of an application without modifying the functional application code). In addition, it may be desirable to share graphical elements among a plurality of objects. However, requiring that objects and associated graphical elements be provided in the same location would cause objects that share graphical elements to need to be provided in the same location, which in some cases may negate the efficiencies of sharing and/or simply not be practical in a given situation.

On the other hand, allowing objects and associated graphical elements to be provided in different locations may be difficult. When an object is accessed, it may be necessary to quickly and accurately access the associated graphical element even though the graphical element may be provided in a location different from the location of the object. Thus, it is desirable to provide a mechanism for accessing a graphical element of an object even when the graphical element is stored in a different location than the object.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Locating a graphical element associated with an object includes obtaining a key for the object, using the key to determine a particular data table containing the graphical element, and using the key to obtain an identifier for the graphical element within the data table. The custom graphical element may be graphical portions of a custom control, or the graphical representation for the whole custom control itself. The data table may be initially provided as a file.

Associating a particular graphical element with an object includes providing the graphical element at a particular location separate from the object, providing a key indicating the particular location and an identifier for the graphical element at the location, and associating the key with the object. The location may be a resource dictionary located within an assembly. The method may also include modifying the key to point to a different graphical element based on run time conditions, such as a user selected theme.

Drawing a graphical element associated with an object includes locating the graphical element, wherein the graphical element is at a location different from the object and after locating the graphical element, drawing the graphical element. Locating the graphical element may include obtaining a key for the object, where the key indicates a particular resource dictionary and a particular location within the resource dictionary.

### DESCRIPTION OF THE DRAWINGS

FIG. 1 is a diagram illustrating a presentation system, an application, objects, and resource dictionary data elements according to an embodiment of the system described herein.

FIG. 2 is a diagram showing an integrated graphical unit that includes a window frame, a title bar, a stock control, and a custom control to illustrate an embodiment of the system described herein.

FIG. 3 is a flowchart illustrating processing performed by a presentation system to obtain a graphical element for an object according to an embodiment of the system described herein.

FIG. 4 is a flowchart illustrating obtaining a location for a graphical element of an object according to an embodiment of the system described herein.

FIG. 5 is a diagram illustrating a resource directory and resource files according to an embodiment of the system described herein.

FIG. 6 is a diagram illustrating a resource dictionary according to an embodiment of the system described herein.

### DETAILED DESCRIPTION

Described herein are various technologies and techniques for facilitating accessing a graphical element associated with an object where the object and the graphical element are provided at different locations. Various embodiments are described more fully below with reference to the accompanying drawings, which form a part hereof, and which show specific exemplary embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

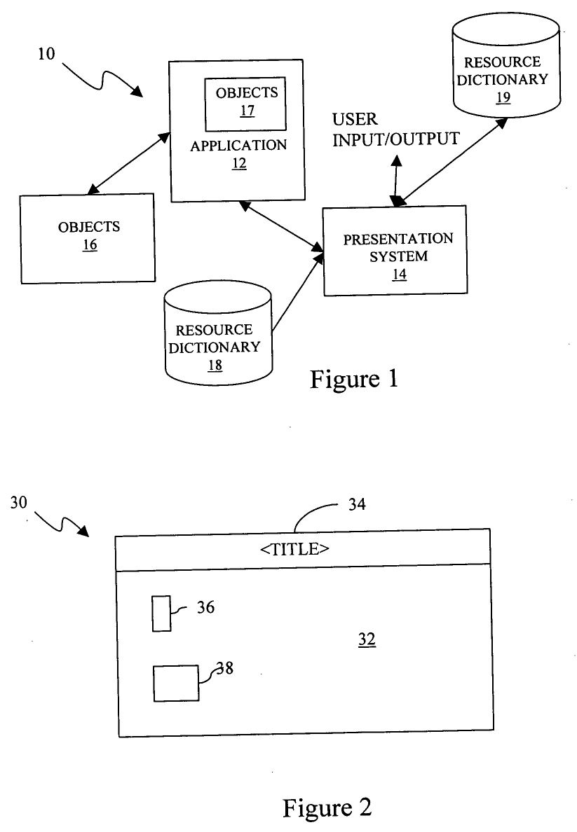

Referring to FIG. 1, a diagram 10 illustrates a plurality of system components including an application 12, a presentation system 14, a first set of objects 16, a second set of objects 17, a first resource dictionary data element 18, and a second resource dictionary data element 19. The application 12 represents any appropriate application that operates, at least in part, by presenting information to a user and/or receiving input from a user. The application 12 interacts (e.g., by API calls) with the presentation system 14 to facilitate user input and output to and from the application 12. Except as described elsewhere herein, the presentation system 14 may be any conventional presentation system used to provide appropriate functionality to the application 12 to allow for user input and output. For example, the presentation system 14 may draw window frames, menus, etc. and receive and pass on to the application user input in the form of typed keys, mouse clicks, etc.

The first set of objects 16 may be separate from the application 12 while the second set of objects 17 may be part of the application. The application 12 may interact with the first set of objects 16. There may be any number of other sets of objects (not shown) used by the application 12. A subset of objects within the sets of objects 16, 17 may use graphical elements. The sets of objects 16, 17 may represent any type of objects, including objects associated with graphical controls.

For particular objects of the sets of the objects 16, 17 that use graphical elements, the resource dictionary data elements 18, 19 may contain information that allows the presentation system 14 to draw the various graphical elements. The resource dictionary data elements 18, 19 represent any data in any appropriate format capable of storing graphical elements and providing access thereto in a manner that is consistent with the description provided herein. There may be a plurality of resource dictionary data elements (or the equivalent) in a plurality of different formats. Note that having the resource dictionary data elements 18, 19 be separate from the application 12, the presentation system 14, and the sets of objects 16, 17 allows for separately and independently defining the appearance of any graphical element handled by the presentation system 14. Accordingly, it is possible to independently change the appearance of an object by modifying the resource dictionary data elements 18, 19 without having to modify the application 12 or the presentation system 14 and without having to modify any objects within the sets of objects 16, 17. However, for other embodiments, it is possible to have a portion of one or more of the resource data dictionary elements 18, 19 be part of or integrated with one or more of the sets of objects 16, 17, the application 12, and/or the presentation system 14.

Referring to FIG. 2, an integrated graphical unit 30 includes graphical elements presented to a user by the presentation system 14 at the direction of the application 12. In the integrated graphical unit 30 of the example of FIG. 2, the user is presented with graphical elements that include a window frame 32 having a title bar 34, a first control 36, and a second control 38. The presentation system 14 provides the graphical elements 32, 34, 36, 38 in response to the application 12 making an appropriate call to the presentation system 14. For example, the window frame 32 may be provided in response to the application 12 making a call to the presentation system 14 indicating that a window frame is to be drawn and indicating the dimensions and location of the window frame 32. The title bar 34 may be provided in connection with the same code that creates the window frame 32 or may be handled separately. The graphical elements 32, 34, 36, 38 may be provided by one or both of the resource dictionary data elements 18, 19 while the underlying objects may be provided by the first set of objects 16 and/or by the second set of objects 17.

In an embodiment herein, an integrated graphical unit includes any collection of graphical elements, such as a window and associated elements that may be presented to a user. Elements of an integrated graphical unit may be stored in a data structure (e.g., a tree) containing information indicative of each of the graphical elements (e.g., leaves of the tree). Thus, the integrated graphical unit 30 may be represented by a tree data structure having, as elements, data indicative of the window frame 32, the title bar 34, the stock control 36, and the custom control 38. Of course, other data structures and indeed other mechanisms may be used to maintain information for an integrated graphical unit.

The presentation system 14 may handle drawing graphical elements associated with any number of resource dictionary data elements using a mechanism that associates graphical elements and objects provided in different locations. In an embodiment herein, objects, applications, and/or resource dictionary data elements may be provided in executable code units such as assemblies, which may be loaded into the memory of the computer system on which the application 12 is run.

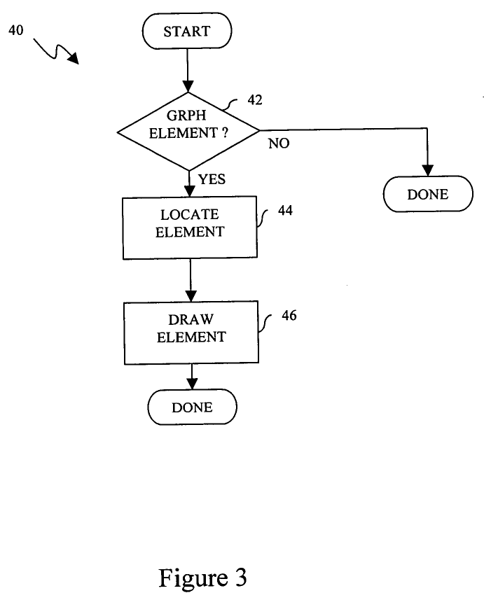

Referring to FIG. 3, a flowchart 40 illustrates steps performed in connection with the presentation system 14 accessing and drawing a graphical element associated with an object. Processing begins at a first test step 42 which determines if there are any graphical elements associated with the object. If not, then processing is complete. Otherwise, control transfers from the test step 42 to a step 44 where the presentation system 14 locates the graphical element. As discussed elsewhere herein, graphical elements for an object may be provided at a location different from the location used for the object. Processing performed at the step 44 is discussed in more detail elsewhere herein. Following step 44 is a step 46 where the presentation system 14 draws the graphical element. Drawing the graphical element at the step 46 may be performed using any number of appropriate techniques depending upon the format of the graphical element. For example, if graphical elements are stored in a jpeg or bitmap format, the processing performed at the step 46 includes conventional, well-known, steps for graphically rendering jpeg or bitmap data. Following the step 46, processing is complete.

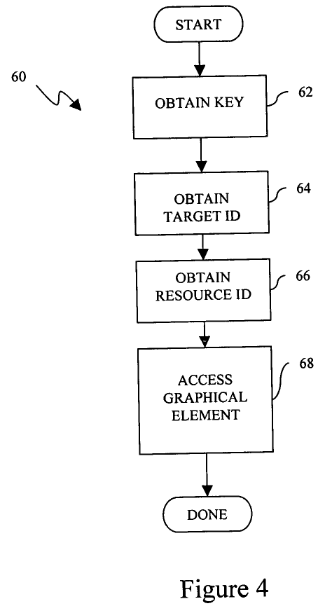

Referring to FIG. 4, a flowchart 60 illustrates in more detail processing performed at the step 44 of the flowchart 40 of FIG. 3 where a location of a graphical element is determined. Processing begins at a first step 62 where a key for the object is obtained. In an embodiment described herein, each object may have a key associated therewith that maps the object to a graphical element at runtime. The key and/or what the key points to may be modified, even at run time, to change the appearance of the object. For example, it may be possible to modify the keys based on runtime conditions (e.g., user selectable option or environment conditions) so that, based on the particular runtime conditions, the application user is presented with a different graphical interface to the application. It is also possible to maintain the keys pointing to the same graphical element(s) and simply modify the element(s). Thus, the graphical element(s) pointed to by the key are modified without changing the keys.

In an embodiment herein, the theme of a computer system may determine the overall look of the system, including the rendering of windows, icons, menus, etc. In some instances, the keys may be configured to account for theme changes so that the keys are not modified based on theme changes even though the graphical view of the application changes for the user when the theme changes. In those embodiments, the keys may be configured to automatically point to a different resource file (described elsewhere herein) in response to a change in the theme. Of course, it is possible to also have an alternative embodiment of the system where changes in the theme cause changes to the keys.

Following step 62 is a step 64 where a target ID is obtained from the key. In an embodiment herein, the target ID represents the location (e.g., particular resource dictionary) of the graphical element. The location could be in any appropriate form, including an identifier for a resource dictionary that may or may not be located within an assembly (dll or executable file) or in some other location within a computer system. The target ID may indicate a particular assembly (executable) in which the appropriate resource dictionary is located. Following the step 64 is a step 66 where a resource ID is obtained from the key. In an embodiment herein, the key associated with an object contains a target ID identifying a location of a graphical element and contains a resource ID indicating a particular resource (graphical element) within the location (e.g., the particular entry in the resource dictionary). In an embodiment herein, the resource ID includes a number appended to a base identifier corresponding to the object so that, for example, an object identified as “XYZ” may have graphical elements associated therewith with resource ID's of “XYZ01”, “XYZ02”, etc. Of course, any one of a number of other appropriate techniques may be used to provide unique identifiers.

In an embodiment herein, a single instance of an object will only have a single graphical element associated therewith at any particular time where the particular graphical element may be changed by changing the key and/or by changing the graphical element to which the key points. However, other schemes are possible where multiple graphical elements may be associated with a single object (single key) at any particular time. For example, a single object may have a corresponding key that points to different graphical elements according to a user-selected theme. In any event, a resource dictionary may contain multiple versions of a graphical element that differ according to the particular resource ID. Following the step 66 is a step 68 where the graphical element is accessed to obtain the information necessary to draw the corresponding object. Following step 68, processing is complete.

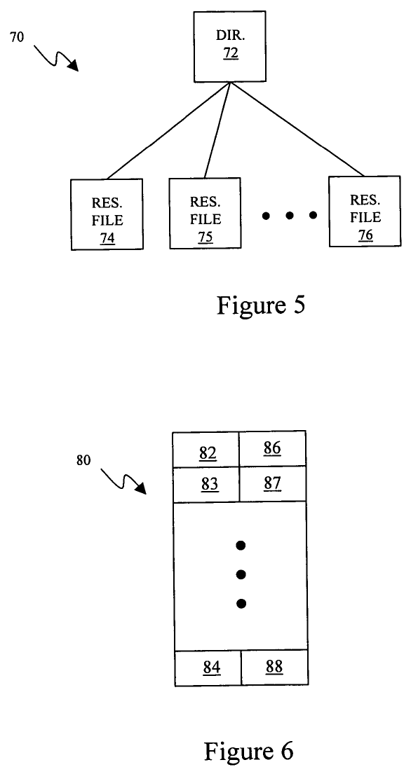

Referring to FIG. 5, a diagram 70 illustrates a mechanism for providing the resource dictionary data element 18 or the resource dictionary data element 19 illustrated by the diagram 10 of FIG. 1 where the particular resource file that is used varies according to, for example, a system parameter chosen by a user such as a theme. The diagram 70 illustrates a resource directory 72 and a plurality of resource files 74-76. The resource directory 72 may be provided in any appropriate location on a computer or other processing device that is used to construct the application 12 and/or to run the application 12. Of course, the resource directory 72 may be provided in different forms and in different locations such as accessible Web pages and/or as part of an application's assembly. When the application 12 is compiled by the developer, the resource files 74-76 may also be compiled or at least translated to a different form that allows for more efficient use. Any appropriate file format(s) and/or file types may be used. For example, a markup representation such as XAML may be used and the XAML files may, or may not, be subsequently converted into a binary or other format. In other embodiments, the resource files 74-76 may be maintained in a single file format throughout.

In an embodiment herein, each of the resource files 74-76 represents a particular theme (e.g., “classic”) and the contents of each of the resource files 74-76 include entries for each graphical element that may be modified in response to a theme change. Thus, an application developer could create code that includes an object (either a custom object or one that is provided with the presentation system 14) and could then populate each of the resource files 74-76 with data indicating how the object should look under different conditions. Then, depending on the run time conditions, a key associated with the object may be provided to indicate which directory, which of the resource files 74-76 in the chosen directory, and which graphical element (resource) therein to use.

Of course, other techniques for arranging resource files and corresponding resource dictionaries may be used, including providing all resources (graphical elements) in a single file (source) that is converted into a single assembly. It is also worth noting that one or more resource dictionaries may be included in the assembly that includes the application and/or the assembly that includes at least some of the objects. So it may be noted that one or more resource dictionaries may actually exist in one or more assemblies used by an application. Thus, by using a key as explained herein, it becomes possible to locate a graphical element resource in a resource dictionary that exists in an assembly external to the one in which the object associated with that key exists.

Referring to FIG. 6, a table 80 illustrates a possible implementation of a resource dictionary provided in one of the resource files 74-76. The table 80 includes a plurality of index entries 82-84, each of which represents a particular type of graphical element including, possibly, graphical elements associated with a user defined control. The table 80 also includes a plurality of information entries 86-88, each of which corresponds to one of the index entries 82-84. Thus, for example, the information entry 86 corresponds to the index entry 82, the information entry 87 corresponds to the index entry 83, etc. Each of the information entries 86-88 contains visual information about the appearance of a corresponding one of the graphical elements represented by each of the index entries 82-84. The information entries 86-88 may be implemented using any appropriate means including providing data or pointers to data that uses any one of a number of possible formats for representing graphical data (e.g., bitmap data, jpeg data, etc.). The resource dictionary may be implemented using any appropriate data table consistent with the description provided herein.

The operations described herein may be referred to variously as steps, operations, structural devices, acts or modules. However, it is noted that these operations, structural devices, acts and modules may be implemented in software, in firmware, in special purpose digital logic, a computer readable medium having computer executable instructions, and any combination thereof without deviating from the spirit and scope of the system described herein. Furthermore, it should be appreciated that while a particular order of operation is set forth with respect to the logical operations illustrated herein, other orders of operation are possible, unless indicated otherwise or apparent from the context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of locating a graphical element associated with an object, comprising:
obtaining a key for the object, wherein the key is associated with the object;
using the key to determine a particular data table containing the graphical element; and
using the key to obtain an identifier for the graphical element within the data table.

2. A method, according to claim 1, wherein the custom graphical element is one of: graphical portions of a custom control and the entire custom control.

3. A method, according to claim 1, wherein the data table is initially provided as a file.

4. A method, according to claim 3, wherein the file is one of a plurality of possible files.

5. A method, according to claim 1, wherein the graphical element is part of an integrated graphical unit.

6. A method, according to claim 7, wherein the integrated graphical unit corresponds to a window.

7. A computer readable medium having computer executable instructions for performing the steps recited in claim 1.

8. A system having at least one processor that performs the steps recited in claim 1.

9. A method of associating a particular graphical element with an object, comprising:
providing the graphical element at a particular location separate from the object;
providing a key indicating the particular location and an identifier for the graphical element at the location; and
associating the key with the object.

10. A method, according to claim 9, wherein the location is a resource dictionary located within an assembly.

11. A method, according to claim 10, further comprising:
modifying the key associated with the object to point to a different graphical element based on run time conditions.

12. A method, according to claim 11, wherein the run time conditions include a theme chosen by a user.

13. A method, according to claim 10, wherein the graphical element is part of an integrated graphical unit.

14. A method, according to claim 13, wherein the integrated graphical unit corresponds to a window.

15. A computer readable medium having computer executable instructions for performing the steps recited in claim 10.

16. A system having at least one processor that performs the steps recited in claim 10.

17. A method of drawing a graphical element associated with an object, comprising:
locating the graphical element, wherein the graphical element is at a location different from the object; and
after locating the graphical element, drawing the graphical element.

18. A method, according to claim 17, wherein locating the graphical element includes obtaining a key for the object, wherein the key indicates a particular resource dictionary and a particular location within the resource dictionary.

19. A computer readable medium having computer executable instructions for performing the steps recited in claim 17.

20. A system having at least one processor that performs the steps recited in claim 17.
